(19) United States
(12) Patent Application Publication
(10) Pub. No.: US 2019/0309231 A1
(43) Pub. Date: Oct. 10, 2019

(54) CATALYSTS AND METHODS FOR DISTILLATE END POINT REDUCTION

(71) Applicant: ExxonMobil Research and Engineering Company, Annandale, NJ (US)

(72) Inventors: Brandon J. O'Neill, Lebanon, NJ (US); Sara L. Yohe, Houston, TX (US); Ajit B. Dandekar, The Woodlands, TX (US)

(21) Appl. No.: 16/359,099

(22) Filed: Mar. 20, 2019

Related U.S. Application Data
(60) Provisional application No. 62/653,892, filed on Apr. 6, 2018.

(51) Int. Cl. C10G 69/02; B01J 29/03; B01J 35/10

(52) U.S. Cl. CPC C10G 69/02; B01J 29/0325; B01J 23/42; B01J 35/1057; B01J 35/1019

(57) ABSTRACT

Systems and methods are provided for reducing the end point of distillate fuel boiling range fractions while reducing or minimizing conversion of the distillate fuel to naphtha or light ends. To perform end point reduction, a distillate boiling range fraction is exposed to a conversion catalyst that has a total surface area of at least 200 m²/g, an average pore size of 12 Angstroms or more, and/or a low acidity, where the conversion catalyst includes a supported Group 8-10 metal, such as a supported Group 8-10 noble metal. Such a conversion catalyst can have improved activity for reducing end point of a distillate fuel fraction while reducing or minimizing conversion relative to 177° C. Performing end point reduction using such a catalyst can allow for increased yields of distillate fuel boiling range products by allowing increased amounts of heavy feed components to be included in the input to a distillate fuel processing train.

### CROSS-REFERENCE TO RELATED APPLICATIONS

This application claims priority to U.S. Provisional Application Ser. No. 62/653,892 filed Apr. 6, 2018, which is herein incorporated by reference in its entirety.

The subject matter in this application is related to the subject matter in co-pending application Ser. No. 15/715,555, titled “Lubricant Basestock Production with Enhanced Aromatic Saturation”, filed on Sep. 26, 2017.

### FIELD

Systems and methods are provided that can offer enhanced selectivity for reduction of the end point of a distillate boiling range during hydroprocessing.

### BACKGROUND

One of the difficulties in processing distillate fractions is a difference between the desired end point for a diesel fuel fraction and the desired start point for a lubricant fraction. In order to meet various specifications, lubricant boiling range fractions are typically designed to limit the amount of components having a boiling range of less than ˜720° F. (˜380° C.). Similarly, in order to meet various specifications, fractions intended for use as part of a distillate fuel pool are typically designed to limit the amount of components having a boiling range of 650° F. (˜343° C.) or more, or 680° F. (˜360° C.) or more. As a result, for a typical crude fraction, there is a 680° F. (˜360° C.) to 720° F. (˜380° C.) portion (or a ˜343° C. to ˜380° C. portion) that can be difficult to incorporate into either the distillate fuel pool or the lubricant product pool.

Conventionally, one option for incorporating the 343° C. to 380° C. (or 360° C. to 380° C.) portion of a crude fraction and/or other feed into a product pool is to use distillate hydrocracking (or other hydroprocessing) to convert a sufficient amount of the 343° C.+ portion (or 360° C.+ portion) to allow incorporation into the distillate fuel pool. Unfortunately, conventional hydrocracking methods for reducing the end point of a distillate fuel fraction also results in substantial conversion of 343° C.− (or 360° C.−) distillate components into naphtha boiling range components (177° C.−) and/or light ends (C₄₋ components). This cracking of distillate fuel boiling range components to naphtha and/or light ends can reduce the benefit of forming distillate boiling components from the 343° C.-380° C. portion (or 360° C.-380° C. portion) of a feed. What is needed is are systems and methods that can allow for distillate end point reduction while reducing or minimizing the amount of conversion of distillate boiling range components to naphtha boiling range components or light ends.

U.S. Pat. No. 7,192,900 describes hydrocracking catalysts containing USY zeolite with surface areas of greater than about 800 m²/g. The hydrocracking catalysts are described as being selective for producing distillate fuel boiling range products, rather than naphtha and/or light ends, during a fuels hydrocracking process.

### SUMMARY

In various aspects, a method for producing a distillate fuel boiling range product is provided. The method includes exposing a feedstock comprising a T5 distillation point of 149° C. or more and a T90 distillation point of 370° C. or more in the presence of a conversion catalyst under conversion conditions to form a converted effluent. The conversion catalyst can have a surface area of 200 m²/g or more, an average pore size of 12 Angstroms or more, and/or a collidine adsorption of 300 μmol/g or less. The conversion catalyst can further include 0.01 wt % to 5.0 wt % of a Group 8-10 noble metal supported on the conversion catalyst. The conversion conditions can be effective to form a converted effluent having a T95 distillation point of 360° C. or less, or 350° C. or less. Optionally, the conversion conditions can be effective for conversion of 30 wt % or more of the feedstock relative to a conversion temperature of 177° C. (or 35 wt % or more).

In various aspects, a system for producing a distillate fuel boiling range product is also provided. The system can include a hydrotreating reactor comprising a hydrotreating feed inlet, a hydrotreating effluent outlet, and at least one fixed catalyst bed comprising a hydrotreating catalyst. The system can further include a separation stage having a first separation stage inlet and a second separation stage inlet. The first separation stage inlet can be in fluid communication with the hydrotreating effluent outlet. Optionally, the separation stage can further comprise a plurality of separation stage liquid effluent outlets, with one or more of the separation stage liquid effluent outlets corresponding to product outlets. The system can also include a conversion reactor comprising a conversion feed inlet, a converted effluent outlet, and at least one fixed catalyst bed comprising a conversion catalyst. The conversion feed inlet can be in fluid communication with at least one separation stage liquid effluent outlet. The conversion catalyst can have a surface area of 200 m²/g or more, an average pore size of 12 Angstroms or more, and/or a collidine adsorption of 300 μmol/g or less. The conversion catalyst can further include 0.01 wt % to 5.0 wt % of a Group 8-10 noble metal supported on the conversion catalyst.

### BRIEF DESCRIPTION OF THE DRAWINGS

FIG. 1 shows an example of a processing system suitable for processing a feed to perform distillate end point reduction.

FIG. 2 shows characterization data for the process effluent from exposing a distillate feed with a T90 distillation point of greater than 370° C. to various catalysts for distillate end point reduction.

FIG. 3 shows additional characterization data for the process effluent in FIG. 2.

FIG. 4 shows additional characterization data for the process effluent in FIG. 2.

FIG. 5 shows characterization data for the process effluent from exposing a distillate feed with a T90 distillation point of greater than 370° C. to an additional catalyst for distillate end point reduction.

### DETAILED DESCRIPTION

### Overview

All numerical values within the detailed description and the claims herein are modified by “about” or “approximately” the indicated value, and take into account experimental error and variations that would be expected by a person having ordinary skill in the art.

In various aspects, systems and methods are provided for reducing the end point of distillate fuel boiling range fractions while reducing or minimizing conversion of the distillate fuel to naphtha or light ends. Preferably, the end point reduction can be performed under sweet hydroprocessing conditions. To perform end point reduction, a distillate boiling range fraction is exposed to a conversion catalyst that has a total surface area of at least 200 m²/g, an average pore size of 12 Angstroms or more, and/or a low acidity (such as an Alpha value of 20 or less), where the conversion catalyst includes a supported Group 8-10 metal, such as a supported Group 8-10 noble metal (based on the numbering from the IUPAC periodic table). Optionally, the conversion catalyst can further have an average pore size of 20 Angstroms or more, or 30 Angstroms or more, or 40 Angstroms or more. Such a conversion catalyst can have improved activity for reducing end point of a distillate fuel fraction while reducing or minimizing conversion relative to 177° C. Performing end point reduction using such a catalyst can allow for increased yields of distillate fuel boiling range products by allowing increased amounts of heavy feed components to be included in the input to a distillate fuel processing train.

Traditionally, distillate hydroprocessing can be used as a method for producing a distillate fuel boiling range product with a reduced heteroatom content. Depending on the nature of the feed, the distillate hydroprocessing can also be used to reduce the end boiling point and/or the T95 boiling point of the resulting product. Performing end point reduction can allow heavier components to be included in the initial feed while still producing a bottoms distillation product that has a suitable boiling range for use in a distillate fuel pool. Unfortunately, performing a conventional distillate hydroprocessing method at sufficient severity to achieve a desired level of end point reduction typically also results in substantial conversion of the feed relative to 177° C. This means that a portion of the distillate feed is downgraded to naphtha or light ends type products. However, it has been unexpectedly discovered that the catalysts described herein having a high surface area and low acidity can provide unexpectedly high levels of distillate end point conversion while reducing or minimizing the amount of conversion of a feed relative to 177° C.

The conversion catalysts described here can provide unexpectedly high levels of distillate end point conversion while minimizing naphtha and light gas production for feeds having a T90 distillation point of 370° C. or more, or 380° C. or more, when producing a product effluent with a T95 distillation point of 360° C. or less, or 350° C. or less. This combination of features is beneficial, for example, when upgrading feeds formed from a crude fraction that is used for distillate and lubricant production. Components boiling below ˜720° F. (˜380° C.) are not desirable during lubricant production, so such portions are typically fractionated out prior to lubricant processing. Due to practical considerations, a fractionation to exclude 380° C.− (or 370° C.−) components from a feed for lubricant processing can result in a distillate feed that includes a substantial portion of 380° C.+ (or 370° C.+) components, such as 10 wt % or more. For feeds with T90 distillation points less than 380° C., or less than 370° C., amorphous aromatic saturation catalysts can potentially provide suitable activity for end point reduction to provide a product with a T95 distillation point of 360° C. or less. However, for feeds with T90 distillation points of 370° C. or more, or 380° C. or more, the catalysts described herein provided unexpectedly beneficial activity for the higher levels of end point reduction needed to produce a product with a T95 distillation point of 350° C. or less.

### Definitions

In this discussion, the distillate fuel boiling range is defined as 350° F. (177° C.) to 680° F. (360° C.). It is noted that due to practical limitations during fractionation (or other boiling point based separation) of hydrocarbon-like fractions, a distillate fuel boiling range fraction formed according to the methods described herein may have T5 and/or T95 distillation points corresponding to the above values (or T10 and/or T90 distillation points), as opposed to having initial/final boiling points corresponding to the above values. For example, some distillate fuel boiling range product fractions can have a T5 distillation point of 177° C. or more and a T95 distillation point of 360° C. or less. In some optional aspects, a distillate fuel boiling range product fraction can have a T5 distillation point of 177° C. and a T95 distillation point of 343° C. In this discussion, distillation profiles for a feed can be determined according to ASTM D2887. In the event that D2887 is unsuitable for a fraction for some reason, D86 can be selected next. If both D2887 and D86 are unsuitable for a fraction for some reason, D7169 can be used.

As understood by those of skill in the art, specifying an amount of conversion relative to a conversion temperature is a method for specifying the severity of reaction conditions independent of the nature of the particular feed. Thus, specifying an amount of conversion is commonly used as an alternative to specifying conditions such as temperature and pressure when specifying reaction severity. In this discussion, the amount of conversion relative to a conversion temperature (such as 177° C. or 343° C.) is defined based on the difference between the weight of the effluent that boils above the conversion temperature and the weight of the feed that boils above the conversion temperature. This difference is divided by the weight of the feed that boils above the conversion temperature to produce a normalized value (i.e., a weight percent based on the portion of the feed that boils above the conversion temperature).

The boiling range for feedstocks used to make distillate fuels is broader, due to the ability to perform end point reduction. For example, for a feedstock, the distillate boiling range is defined as a T5 to T90 distillation range of 350° F. (177° C.) to 790° F. (˜420° C.), or alternatively as 350° F. (177° C.) to 750° F. (˜400° C.), or 350° F. (177° C.) to 720° F. (˜380° C.), or 350° F. (177° C.) to 700° F. (˜370° C.). Such a feedstock for production of distillate fuel boiling range products can potentially have a final boiling point of 450° C. or more, or 475° C. or more, or 500° C. or more, such as up to 525° C. or possibly still higher. Additionally or alternately, a feedstock having a T90 distillation point of 400° C. or less can have a T95 distillation point of 420° C. or less. In some aspects, the distillate fuel boiling range fraction of a hydroprocessing effluent can correspond to a bottoms fraction from a final hydroprocessing stage. In various aspects, the initial boiling point can vary widely, depending on how much kerosene or other lighter distillate components are included in a feedstock. The boiling point for a feed at a given weight percentage can be determined by any convenient method, such as the method specified in D2887.

With regard to other boiling ranges, the lubricant boiling range is defined as 720° F. (˜380° C.) to 1050° F. (566° C.). The naphtha boiling range is defined as 50° F. (˜10° C., roughly corresponding to the lowest boiling point of a pentane isomer) to 350° F. (177° C.). Compounds with a boiling point below the naphtha boiling range (C₄₋) can be referred to as light ends. It is noted that due to practical consideration during fractionation (or other boiling point based separation) of hydrocarbon-like fractions, a naphtha or lubricant boiling range fraction may have T5 and T95 distillation points corresponding to the above values (or T10 and T90 distillation points), as opposed to having initial/final boiling points corresponding to the above values.

In this discussion, conditions may be provided for various types of hydroprocessing of feeds or effluents. Examples of hydroprocessing can include, but are not limited to, one or more of hydrotreating, hydrocracking, catalytic dewaxing, and hydrofinishing/aromatic saturation. Such hydroprocessing conditions can be controlled to have desired values for the conditions (e.g., temperature, pressure, LHSV, treat gas rate) by using at least one controller, such as a plurality of controllers, to control one or more of the hydroprocessing conditions. In some aspects, for a given type of hydroprocessing, at least one controller can be associated with each type of hydroprocessing condition. In some aspects, one or more of the hydroprocessing conditions can be controlled by an associated controller. Examples of structures that can be controlled by a controller can include, but are not limited to, valves that control a flow rate, a pressure, or a combination thereof; heat exchangers and/or heaters that control a temperature; and one or more flow meters and one or more associated valves that control relative flow rates of at least two flows. Such controllers can optionally include a controller feedback loop including at least a processor, a detector for detecting a value of a control variable (e.g., temperature, pressure, flow rate, and a processor output for controlling the value of a manipulated variable (e.g., changing the position of a valve, increasing or decreasing the duty cycle and/or temperature for a heater). Optionally, at least one hydroprocessing condition for a given type of hydroprocessing may not have an associated controller.

In this discussion and the claims below, a zeolite is defined to refer to a crystalline material having a porous framework structure built from tetrahedra atoms connected by bridging oxygen atoms. Examples of known zeolite frameworks are given in the “Atlas of Zeolite Frameworks” published on behalf of the Structure Commission of the International Zeolite Association”, 6th revised edition, Ch. Baerlocher, L. B. McCusker, D. H. Olson, eds., Elsevier, New York (2007) and the corresponding web site, http://www.iza-structure.org/databases/. Under this definition, a zeolite can refer to aluminosilicates having a zeolitic framework type as well as crystalline structures containing oxides of heteroatoms different from silicon and aluminum. Such heteroatoms can include any heteroatom generally known to be suitable for inclusion in a zeolitic framework, such as gallium, boron, germanium, phosphorus, zinc, and/or other transition metals that can substitute for silicon and/or aluminum in a zeolitic framework.

### High Surface Area, Low Acidity Conversion Catalysts

A conversion catalyst with improved activity for distillate end point reduction while reducing or minimizing conversion relative to 177° C. can correspond to a high surface area, low acidity catalyst. Optionally but preferably, the catalyst can further have an average pore size of 12 Angstroms or more, or 20 Angstroms or more, or 25 Angstroms or more, or 30 Angstroms or more, or 40 Angstroms or more.

Hydrocracking catalysts are typically used to perform at least part of the distillate end point reduction in situations where 10 wt % or more of the feed for distillate fuel production corresponds to a 650° F.+ (343° C.+) portion, or a 700° F.+ (370° C.+) portion, or a 720° F.+ (˜380° C.+) portion. Some hydrocracking catalysts can correspond to catalysts with a large number of acidic sites and/or high acidity. Such catalysts can include amorphous catalysts, such as amorphous silica-alumina or alumina.

Other conventional hydrocracking catalysts can generally correspond to catalysts with high activity for conversion of a feed relative to a conversion temperature of 370° C. Some conventional hydrocracking catalysts can include a structure having a zeolitic framework (i.e., a framework recognized by the International Zeolite Association), with the zeolitic framework including a pore channel corresponding to a 10-member or 12-member ring in the framework. Such catalysts can optionally also include a binder. Examples of this type of hydrocracking catalyst include catalysts based on a structure having a MFI framework (such as ZSM-5), a MRE framework (such as ZSM-48), a MOR framework (such as mordenite), a *BEA framework (such as zeolite Beta), or a FAU framework (such as Y zeolite).

In contrast to the above conventional hydrocracking catalysts, it has been discovered that an improved combination of distillate end point reduction and yield of distillate fuel boiling range products can be achieved using conversion catalysts having a different set of characteristics. The conversion catalysts providing an improved combination of distillate end point reduction and yield of distillate fuel boiling range products can correspond to catalysts having a high surface area and/or a low acidity. Catalysts having a high surface area can correspond to catalysts with a total surface area of at least 200 m²/g as determined by BET adsorption (N₂), or at least 300 m²/g, or at least 400 m²/g, at least 500 m²/g, or at least 600 m²/g, or at least 700 m²/g, such as up to 1200 m²/g or more, or up to 1500 m²/g or more. In particular, a catalyst can have a total surface area of 200 m²/g to 1500 m²/g, or 400 m²/g to 1500 m²/g, or 600 m²/g to 1500 m²/g, or 700 m²/g to 1200 m²/g.

With regard to acidity, various methods are available for evaluating the acidity of a catalyst. One option is to characterize a catalyst based on an Alpha value. Catalysts having a low Alpha value can correspond to catalysts with an Alpha value of 50 or less, or 20 or less, or 10 or less, or 5 or less, such as down to an Alpha value of 1.0 or possibly lower. Additionally, the high total surface area and/or low Alpha value catalysts can include one or more Group 8-10 metals (such as one or more Group 8-10 noble metals) as a hydrogenation metal. Conventionally, acidic sites are believed to correspond to sites for hydrocracking activity. The acid sites/acidity of a catalyst can be determined using the Alpha value test. The Alpha value test is a measure of the cracking activity of a catalyst and is described in U.S. Pat. No. 3,354,078 and in the Journal of Catalysis, Vol. 4, p. 527 (1965); Vol. 6, p. 278 (1966); and Vol. 61, p. 395 (1980), each incorporated herein by reference as to that description. The experimental conditions of the test used herein include a constant temperature of 538° C. and a variable flow rate as described in detail in the Journal of Catalysis, Vol. 61, p. 395.

Another potential acidity test is to determine the amount of collidine the catalyst will absorb. The test procedure for determining collidine adsorption on a catalyst (such as the crystals prior to addition of metal or binder, or the extruded catalyst particles including metals and/or binder) or support sample is defined as follows: Collidine adsorption is determined using a thermogravimetric analyzer (e.g. a Q5000 thermogravimetric analyzer from TA Instruments). To determine collidine adsorption, a sample of a catalyst or support is loaded into the instrument and then the surface is dried by ramping the temperature of the sample in flowing N₂ to 200° C. at 10° C./min. The temperature is then held at 200° C. for one hour. After holding at 200° C., collidine is sparged from a reservoir held at 35° C. with flowing N₂ for one hour. During the collidine exposure the sample remains at 200° C. After the one hour exposure to the collidine, the sparging is stopped and the sample is held in flowing N₂ at 200° C. for one additional hour to remove excess collidine. The amount of adsorbed collidine is defined as the difference between mass of the sample at the end of the procedure versus the mass of the sample immediately before sparging begins. In various aspects, a low acidity catalyst and/or low acidity support can correspond to a catalyst or support that has a collidine adsorption of 300 μmol/g or less, or 250 μmol/g or less.

Still another option for characterizing the acidity of a catalyst or a support is based on analysis if infrared (IR) absorption after exposing the catalyst surface (or support surface) to pyridine. The analysis of the IR absorption spectrum is used to quantify Bronsted and Lewis acid sites based on the adsorption of pyridine onto the sample surface. The two types of sites are distinguished by the different frequency of IR absorption in the pyridine-acid site complex. IR radiation absorbs into a Bronsted acid site-pyridine complex at 1545 cm⁻¹. IR radiation absorbs into a Lewis acid site-pyridine complex at 1445-1455 cm⁻¹. The number of sites of each type is quantified based upon the intensity of the IR absorption. The test procedure is as follows: 1) Outgas sample for two hours at 400° C. in vacuum. 2) Cool to 80° C. and leak check manifold and sample cell. 3) Take background spectrum. 4) Reconnect cell and heat the sample to 150° C. 5) Isolate the sample cell. 6) Fill manifold with pyridine vapor over the course of 20 min. 7) Close pyridine dosage valve. 8) Expand the pyridine vapor into the sample cell for 30 min. 9) Evacuate cell for 30 min at 150° C. 10) Cool to 80° C. 11) Take IR spectrum of pyridine-exposed sample and compare appropriate peaks with background spectrum and/or subtract out background spectrum. In various aspects, a low acidity catalyst and/or low acidity support can correspond to a catalyst or support that has a Bronsted acid site density (as determined by IR absorption on a pyridine-exposed sample) of 100 μmol/g or less. Additionally or alternately, a low acidity catalyst and/or low acidity support can correspond to a catalyst or support that has a Lewis acid site density (as determined by IR absorption on a pyridine-exposed sample) of 150 μmol/g or less. Further additionally or alternately, a low acidity catalyst and/or low acidity support can correspond to a catalyst or support that has a combined Bronsted acid site plus Lewis acid site density (as determined by IR absorption on a pyridine-exposed sample) of 250 μmol/g or less.

The catalysts having an improved combination of distillate end point reduction and yield of distillate fuel boiling range products can also have an average pore size of 12 Angstroms or more, or 20 Angstroms or more, or 25 Angstroms or more, or 30 Angstroms or more, or 40 Angstroms or more, such as up to 120 Angstroms or possibly still higher. The pore size distribution (such as pore width) relative to the pore volume of a catalyst can be determined using BET adsorption with N₂ as the adsorbed molecule. The average pore size can be defined based on a volume average across all pores in the pore size distribution.

Without being bound by any particular theory, it is believed that high surface area, large pore, low acidity hydrocracking catalysts as described herein can have increased selectivity for cracking large molecules, such as multi-ring compounds. Large molecules have a higher energy of physical adsorption, implying that they can selectively adsorb to the surface if they have access. The large pores allow large molecules, such as multi-ring compounds, to have access to a greater portion of the surface area. Multi-ring compounds can include aromatics, naphthenes, and naphthenoaromatics. Such multi-ring compounds are disproportionately represented in the large molecules of the 343° C.+ portion of a feed, or the 360° C.+ portion of a feed. Typical zeolite catalysts have a maximum average pore size of (roughly) 8.0 Angstroms, which may be sufficient to allow access for single-ring compounds, but is believed to be too small to allow access for multi-ring compounds. Increasing the average pore size to 12 Angstroms or more can provide a sufficiently large pore size so that multi-ring compounds can access the portion of the surface area within catalyst pores.

For conventional catalysts, where increased acidity is typically associated with increased cracking, the catalytic activity provided at acidic sites can tend to be selective for cracking of paraffins. This is undesirable when cracking a potential distillate fuel fraction, as long chain paraffins are desirable molecules. By contrast, the catalysts described herein are believed to provide improved cracking activity for multi-ring compounds by providing larger pore channels that allow access of the multi-ring compounds to acidic sites. By increasing the selectivity for cracking of compounds that are present only in the heavier portions of a feed for distillate fuel production, the selectivity for end point reduction can be increased while reducing or minimizing the amount of conversion relative to 177° C. (i.e., conversion to naphtha or light ends). It is noted that the benefit of the catalysts described herein is reduced, minimized, or eliminated if the acidity of the catalyst is too high. Without being bound by any particular theory, this is believed to be due to the adsorption becoming dominated by the chemical adsorption at the active sites rather than by physical adsorption of the total surface.

Examples of materials that can have a high surface area and large pore size include, but are not limited to, mesoporous aluminosilicates (e.g., MCM-41 or MCM-48), mesoporous organosilicas (MOS), periodic mesoporous organosilicas (PMO), SBA-15, KIT-6, ERS-8, hexagonal mesoporous silica (HMS), pre-zeolitic materials, mesoporous silicas (including MSU-H and/or mesoporous silicas doped with metals to incorporate acidity), aluminosilicate gels (such as Sorbead®), silica-alumina hydrates (such as SIRAL®), metal organic frameworks (MOFs), amorphous alumina, amorphous silica, amorphous silica-alumina, and ion exchange resin silica/silicone supports. Optionally, the acidity of a material can be modified, such as by introducing one or more metals and/or metal oxides. Examples of suitable metals (in their metallic state) and/or metal oxides that can be included in a material to adjust acidity (either increase or decrease) can include, but are not limited to, metals and/or corresponding oxides of titanium, tin, vanadium, iron, cobalt, nickel, zinc, manganese, cerium, lanthanum, and yttrium. Optionally, the acidity can be modified by introducing a mixture of one or more metals, one or more metal oxides, or a mixture of at least one metal and at least one metal oxide. For example, acidity modification can be performed by introducing WOₓ, W/Zr, and/or sulfated zirconias onto silica materials.

In some aspects, the catalysts described herein can have a reduced or minimized content of conventional hydrocracking catalyst structures based on zeolitic frameworks. For example, a catalyst having a high surface area and/or low Alpha value can include 25 wt % or less, or 15 wt % or less, or 1.0 wt % or less, or 0.1 wt % or less, such as down to 0 wt %, of crystalline zeolitic structure(s) having a 10-member ring or 12-member ring pore channel. In some alternative aspects, a catalyst having a high surface area and/or low Alpha value can include still higher amounts of crystalline zeolitic structures having a 10-member ring or 12-member ring pore channel, such as 50 wt % or less, or 35 wt % or less, or 20 wt % or less. Catalysts having less than 0.1 wt % of zeolitic structures having a 10-member ring or 12-member pore channel can correspond to catalysts that are substantially free of such zeolitic structures. Additionally or alternately, a catalyst can include 25 wt % or less, or 15 wt % or less, or 1.0 wt % or less, or 0.1 wt % or less, such as down to 0 wt %, of a (crystalline) zeolitic structure. It is noted that a catalyst based on a zeolitic framework structure with a 12-member ring pore channel typically has an average pore size of ˜8.0 Angstroms or less.

Some types of materials that can provide high surface areas when formulated into catalysts can correspond to mesoporous materials, which correspond to materials where a substantial portion of the pore volume of the material corresponds to pores having a pore size of 12 Angstroms or more, or 20 Angstroms or more, or 25 Angstroms or more, or 30 Angstroms or more, or 40 Angstroms or more. A substantial portion of the pore volume can correspond to a material where at least 40% of the pore volume corresponds to pores having a pore size of 12 Angstroms or more (or 20 Angstroms or more, or 30 Angstroms or more, or 40 Angstroms or more), or at least 50%, or at least 70%. Examples of mesoporous materials can include, but are not limited to, mesoporous silicas, MCM-41, and aluminosilicates and/or other isomorphous substituted materials having a framework structure corresponding to MCM-41.

In some aspects, mesoporosity can be introduced into a catalyst by a treatment after formation of catalyst particles. For example, dealumination of a silicoaluminate can potentially add mesoporosity to a silicoaluminate material. The dealumination can be based on steaming of catalyst particles and/or chemical dealumination. Similarly, desilication of a silicon-containing catalyst particle can potentially lead to mesoporosity.

In some aspects, a high surface area catalyst can correspond to a catalyst composed of agglomerates of particles where the high surface area is substantially due to exposed surface area between particles in a catalyst. In such aspects, at least 50% of the surface area can correspond to surface area at the exterior of the particles comprising a catalyst (i.e., not within a pore of a particle), or at least 70%, or at least 90%.

In some aspects, a high surface area, low acidity catalyst can correspond to a material formed by co-precipitation of silica with one or more amorphous metal oxide precursors. This can allow for formation of mixed metal oxides having high surface area. In some aspects, a high surface area, low acidity catalyst can correspond to a crystalline material that contains silica and one or more additional types of metal oxides, such as Al₂O₃, B₂O₃, Ga₂O₃, ZnO, and/or TiO₂. This type of addition of metal oxides can increase the acidity of the crystalline material. The material with increased acidity can still preferably have an Alpha value of 50 or less, or 20 or less, or 10 or less, or 5 or less. The ratio of silica to other metal oxides (by weight) in the crystalline material can be from 10 to 500.

In some aspects, a high surface area, large pore size, low acidity catalyst can correspond to a bound catalyst. When a binder is included, the binder can correspond to an acidic or basic material. The binder can correspond to a higher surface area material than other materials in the catalyst, or the binder can be lower in surface area. In some aspects, the catalyst can be a self-bound catalyst and/or a catalyst without a binder. Examples of binder materials can include, but are not limited to, various types of oxides of aluminum, lanthanum, magnesium, silicon, zinc, boron, titanium, zirconium, yttrium, hafnium, tungsten, molybdenum, cerium, manganese, cobalt, iron, nickel, and combinations thereof.

A high surface area, large pore size, low acidity catalyst can include one or more catalytic metals supported on the catalyst that can serve as hydrogenation metals. The hydrogenation metals supported on the catalyst can optionally be in oxide or sulfide form during hydrocracking. Examples of suitable catalytic metals can include Pt, Pd, Ni, W, Mo, Co, Ru, Rh, Ir, Re, and combinations thereof. In some aspects, the one or more catalytic metals can correspond to Group 8-10 metals and/or noble metals. For example, the one or more catalytic metals can correspond to Pt, Pd, or a combination thereof. In other examples, a catalyst that includes a noble metal as a hydrogenation metal can correspond to a catalyst that includes a mixture of metals. Suitable mixtures of metals can include, but are not limited to, Pt/Pd, Pt/Rh, and Pd/Rh. The amount of hydrogenation metal in the catalyst can be at least 0.01 wt % based on catalyst, or at least 0.1 wt %, or at least 0.15 wt %, or at least 0.2 wt %, or at least 0.25 wt %, or at least 0.3 wt %, or at least 0.5 wt % based on the catalyst. In aspects where the hydrogenation metal corresponds to and/or includes one or more Group 8-10 noble metals, the amount of Group 8-10 noble metal can be from 0.01 wt % to 5 wt %, or from 0.1 wt % to 4 wt %, or from 0.3 wt % to 3.5 wt %. In aspects where the hydrogenation metal corresponds to at least one base metal, the amount of hydrogenation metal can be from 1.0 wt % to 30 wt %.

A variety of options are available for using a high surface area, large pore size, low acidity catalyst for end point reduction. In some aspects, the high surface area, large pore size, low acidity catalyst can be used in a separate reactor. In other aspects, the high surface area, large pore size, low acidity catalyst can be used as at least a portion of the catalyst in a bed in a multi-bed reactor or stage. For example, when making a distillate fuel fraction with a low cloud point, one of the final catalyst beds or the final catalyst bed in a stage can include at least a portion of a dewaxing catalyst. Such catalysts for distillate dewaxing can preferably have low cracking activity. Because distillate dewaxing is often performed under sweet conditions, a high surface area, low acidity catalyst can potentially be used in a stacked bed and/or in a mixed bed with a distillate dewaxing catalyst. More generally, any convenient location within a distillate hydroprocessing train where sweet conditions are available can be suitable for performing distillate end point reduction using a high surface area, low acidity catalyst.

### Configuration Example

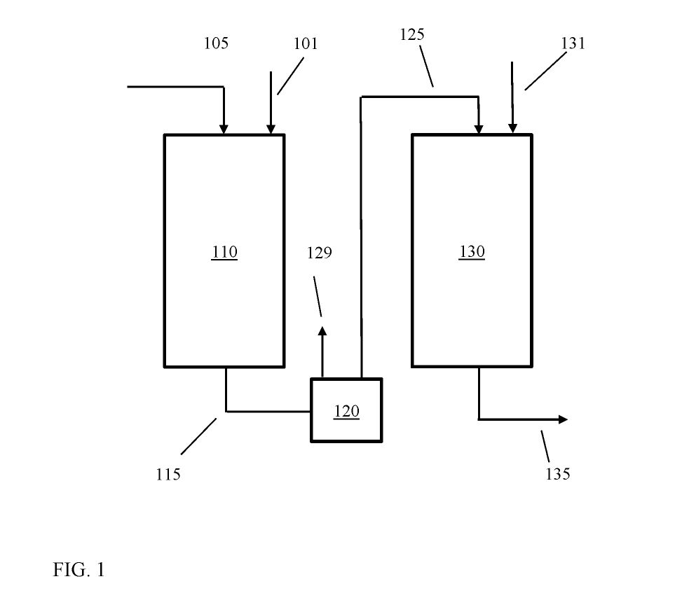

FIG. 1 shows an example of a processing configuration suitable for processing a feedstock to produce distillate fuel boiling range products. The configuration shown in FIG. 1 includes two separate reactors, but it is understood that any convenient number of reactors and/or reaction stages may be used for hydroprocessing of a feed for forming distillate fuel boiling range products. In the example shown in FIG. 1, processing of a feed containing 500 wppm or more of sulfur is shown. In other aspects, a configuration for distillate end point reduction can correspond to a configuration for processing of a sweet feed, containing 500 wppm or less of sulfur, or 200 wppm or less, or 100 wppm or less, or 15 wppm or less.

In the example configuration shown in FIG. 1, a distillate feed boiling range fraction 105 is passed into a first hydroprocessing reactor (or reactors) 110. A hydrogen-containing stream 101 is also passed into the reactor 110. The distillate feed boiling range fraction 105 is exposed to a hydrotreating catalyst, hydrocracking catalyst, aromatic saturation catalyst, or a combination thereof in reactor 110 under first hydroprocessing conditions. In the example configuration shown in FIG. 1, reactor 110 can correspond to a sour processing stage, where the distillate feed boiling range fraction has a sulfur content of 500 wppm or more. The resulting first hydroprocessed effluent 115 is then passed into a separation stage 120 for separation of H₂S and light ends 121 from a remaining effluent portion 125. Optionally, a naphtha boiling range portion of effluent 115 can be removed from the remaining effluent portion 125 as part of stream 121.

The remaining effluent portion 125 can include a sulfur content of 200 wppm or less, or 100 wppm or less, or 15 wppm or less, due to sulfur removal in the first hydroprocessing stage. The remaining effluent portion 125 can then be passed into second hydroprocessing reactor(s) 130, along with optional additional hydrogen stream 131. Second hydroprocessing reactor 130 can include at least one catalyst bed that contains a high surface area, large pore size, low acidity catalyst as described herein. Optionally, any other convenient combination of catalysts can be included in second hydroprocessing reactor 130, such as a dewaxing catalyst that operates primarily by isomerization, an aromatic saturation catalyst, or a combination thereof. Exposing the remaining effluent portion 125 to the catalyst in second hydroprocessing stage 130 under second hydroprocessing conditions can produce a second hydroprocessed effluent 135 containing a 177° C.+ portion with a reduced end point. Optionally, the second hydroprocessed effluent can be fractionated (not shown) to recover a distillate fuel boiling range fraction.

In the configuration shown in FIG. 1, the separation stage 120 reactor can be referred to as being in direct fluid communication with an inlet to second hydroprocessing reactor 130. The first hydroprocessing reactor 110 can be referred to as being in indirect fluid communication with the second hydroprocessing reactor 130 via the separation stage 120.

### Feedstocks

In some aspects, the feedstock generally comprises a mineral oil. By “mineral oil” is meant a fossil/mineral fuel source, such as crude oil, and not the commercial organic product, such as sold under the CAS number 8020-83-5, e.g., by Aldrich. Examples of mineral oils can include, but are not limited to, straight run (atmospheric) gas oils, demetallized oils, coker distillates, cat cracker distillates, heavy naphthas, diesel boiling range distillate fraction, jet fuel boiling range distillate fraction, and/or kerosene boiling range distillate fractions. The mineral oil portion of the feedstock can comprise any one of these example streams or any combination thereof. Optionally but preferably, the feedstock does not contain any appreciable asphaltenes.

Mineral feedstreams suitable for use in various embodiments can have a nitrogen content from <1.0 wppm to 6000 wppm nitrogen, or at least 50 wppm or at least 100 wppm and/or 2000 wppm or less or 1000 wppm or less. In an embodiment, feedstreams suitable for use herein can have a sulfur content from 1 wppm to 40,000 wppm sulfur, or 100 wppm to 30,000 wppm, or 250 wppm to 25,000 wppm. Depending on the aspect, a feed can be hydrotreated to reduce the sulfur and/or nitrogen content prior to exposure to a high surface area, low acidity catalyst. In such embodiments, performing a separation after hydrotreating may be desirable. Either with or without such hydrotreating, in some aspects the sulfur content of a feed for forming distillate fuel boiling range products can be 5000 wppm or less, or 1000 wppm or less, or 500 wppm or less, or 100 wppm or less. In such aspects, the nitrogen content of the feedstock can be 500 wppm or less, or 100 wppm or less, or 50 wppm or less.

In various aspects, the feed can also include portions of the feed that are from biocomponent sources. The feed can include varying amounts of feedstreams based on biocomponent sources, such as vegetable oils, animal fats, fish oils, algae oils, etc. For a biocomponent feed that has been previously hydroprocessed or that is otherwise compatible with conventional refinery equipment, the feed could potentially be entirely derived from a biocomponent source. More typically, the feed can include at least 0.1 wt % of feed based on a biocomponent source, or at least 0.5 wt %, or at least 1 wt %, or at least 3 wt %, or at least 10 wt %, or at least 15 wt %. In such embodiments, the feed can include 90 wt % or less of a feed based on a biocomponent source, or 60 wt % or less, or 40 wt % or less, or 20 wt % or less. In other embodiments, the amount of co-processing can be small, with a feed that includes at least 0.5 wt % of feedstock based on a biocomponent source, or at least 1 wt %, or at least 2.5wt %, or at least 5 wt %. In such an embodiment, the feed can include 20 wt % or less of biocomponent based feedstock, or 15 wt % or less, or 10 wt % or less, or 5 wt % or less.

In this discussion, a biocomponent feed or feedstock refers to a hydrocarbon feedstock derived from a biological raw material component, such as vegetable fats/oils or animal fats/oils, fish oils, pyrolysis oils, and algae lipds/oils, as well as components of such materials, and in some embodiments can specifically include one or more types of lipid compounds. A biocomponent portion of a feed can be a portion that has been previously hydroprocessed, a portion that has not been previously hydroprocessed, or a combination thereof.

First Hydroprocessing Stage—Hydrotreating and/or Hydrocracking

In various aspects, a first hydroprocessing stage can be used to reduce the sulfur and/or nitrogen content of a feedstock for production of distillate fuel boiling range products. The conditions in the initial hydroprocessing stage (hydrotreating and/or hydrocracking) can be sufficient to reduce the sulfur content of the hydroprocessed effluent to 500 wppm or less, or 200 wppm or less, or 100 wppm or less, or 50 wppm or less, or 15 wppm or less, such as down to 1 wppm or possibly still lower. Additionally or alternately, the conditions in the initial hydroprocessing stage can be sufficient to reduce the nitrogen content to 100 wppm or less, or 50 wppm or less, or 10 wppm or less, such as down to 1 wppm or possibly still lower.

In aspects that include hydrotreating as part of the initial hydroprocessing stage, the hydrotreating catalyst can comprise any suitable hydrotreating catalyst, e.g., a catalyst comprising at least one Group 8-10 non-noble metal (for example selected from Ni, Co, and a combination thereof) and at least one Group 6 metal (for example selected from Mo, W, and a combination thereof), optionally including a suitable support and/or filler material (e.g., comprising alumina, silica, titania, zirconia, or a combination thereof). The hydrotreating catalyst can be a bulk catalyst or a supported catalyst. Preferred metal catalysts include cobalt/molybdenum (1-10% Co as oxide, 10-40% Mo as oxide), nickel/molybdenum (1-10% Ni as oxide, 10-40% Co as oxide), or nickel/tungsten (1-10% Ni as oxide, 10-40% W as oxide) on a refractory support, such as silica, alumina, or silica-alumina.

In various aspects, hydrotreating conditions can include temperatures of 200° C. to 450° C., or 315° C. to 425° C.; pressures of 250 psig (˜1.8 MPag) to 5000 psig (˜34.6 MPag) or 500 psig (˜3.4 MPag) to 3000 psig (˜20.8 MPag), or 800 psig (˜5.5 MPag) to 2500 psig (˜17.2 MPag); Liquid Hourly Space Velocities (LHSV) of 0.2-10 h⁻¹; and hydrogen treat rates of 200 scf/B (35.6 m³/m³) to 10,000 scf/B (1781 m³/m³), or 500 (89 m³/m³) to 10,000 scf/B (1781 m³/m³).

### Conditions for Distillate End Point Reduction

In various aspects, distillate end point reduction can be performed by exposing a feed to a high surface area, large pore size, low acidity catalyst under end point reduction conditions. End point reduction conditions can correspond to conditions suitable for conversion relative to 343° C. while reducing or minimizing conversion relative to 350° F. (˜177° C.). Suitable conditions can include temperatures of 550° F. (˜288° C.) to 750° F. (˜400° C.), or 600° F. (˜316° C.) to 750° F. (˜400° C.); hydrogen partial pressures of from 500 psi-a to 5000 psi-a (˜3.5 MPa-a to 34.6 MPa-a), or 1000 psi-a to 2500 psi-a (˜6.9 MPa-a to 17.3 MPa-a); liquid hourly space velocities of from 0.05 h⁻¹ to 10 h⁻¹; and hydrogen treat gas rates of from 35.6 m³/m³ to 1781 m³/m³ (200 SCF/B to 10,000 SCF/B).

In some aspects, the conditions for end point reduction can correspond to conditions selected for another process, such as distillate hydrotreating or distillate dewaxing. For example, if a high surface area, low acidity catalyst is used as part of a stacked bed of catalyst in combination with a distillate dewaxing catalyst, the processing conditions can correspond to dewaxing conditions.

In aspects where catalytic dewaxing is included as part of the hydroprocessing, the dewaxing catalysts are zeolites (and/or have zeolitic framework structures) that perform dewaxing primarily by isomerizing a hydrocarbon feedstock. More preferably, the catalysts are zeolites with a unidimensional pore structure. Suitable catalysts include 10-member ring pore zeolitic framework structures, such as EU-1, ZSM-35 (or ferrierite), ZSM-11, ZSM-57, NU-87, SAPO-11, and ZSM-22. Preferred materials are EU-2, EU-11, ZBM-30, ZSM-48, or ZSM-23. Note that a zeolite having the ZSM-23 structure with a silica to alumina ratio of from 20:1 to 40:1 can sometimes be referred to as SSZ-32. Other zeolitic crystals that are isostructural with the above materials include Theta-1, NU-10, EU-13, KZ-1, and NU-23.

In various embodiments, the dewaxing catalysts can further include a metal hydrogenation component. The metal hydrogenation component is typically a Group 6 and/or a Group 8-10 metal. Preferably, the metal hydrogenation component is a Group 8-10 noble metal. Preferably, the metal hydrogenation component is Pt, Pd, or a mixture thereof.

The metal hydrogenation component may be added to the dewaxing catalyst in any convenient manner. One technique for adding the metal hydrogenation component is by incipient wetness. For example, after combining a zeolite and a binder, the combined zeolite and binder can be extruded into catalyst particles. These catalyst particles can then be exposed to a solution containing a suitable metal precursor. Alternatively, metal can be added to the catalyst by ion exchange, where a metal precursor is added to a mixture of zeolite (or zeolite and binder) prior to extrusion.

The amount of metal in the dewaxing catalyst can be at least 0.1 wt % based on catalyst, or at least 0.15 wt %, or at least 0.2 wt %, or at least 0.25 wt %, or at least 0.3 wt %, or at least 0.5 wt % based on catalyst. The amount of metal in the catalyst can be 20 wt % or less based on catalyst, or 10 wt % or less, or 5 wt % or less, or 2.5 wt % or less, or 1 wt % or less. For aspects where the metal is Pt, Pd, another Group 8-10 noble metal, or a combination thereof, the amount of metal can be from 0.1 to 5 wt %, preferably from 0.1 to 2 wt %, or 0.25 to 1.8 wt %, or 0.4 to 1.5 wt %. For aspects where the metal is a combination of a non-noble Group 8-10 metal with a Group 6 metal, the combined amount of metal can be from 0.5 wt % to 20 wt %, or 1 wt % to 15 wt %, or 2.5 wt % to 10 wt %.

A dewaxing catalyst can also include a binder. In some embodiments, the dewaxing catalysts used in process according to the invention are formulated using a low surface area binder, a low surface area binder represents a binder with a surface area of 100 m²/g or less, or 80 m²/g or less, or 70 m²/g or less, such as down to 40 m²/g or still lower.

Alternatively, the binder and the zeolite particle size can be selected to provide a catalyst with a desired ratio of micropore surface area to total surface area. In dewaxing catalysts used according to the invention, the micropore surface area corresponds to surface area from the unidimensional pores of zeolites in the dewaxing catalyst. The total surface corresponds to the micropore surface area plus the external surface area. Any binder used in the catalyst will not contribute to the micropore surface area and will not significantly increase the total surface area of the catalyst. The external surface area represents the balance of the surface area of the total catalyst minus the micropore surface area. Both the binder and zeolite can contribute to the value of the external surface area. Preferably, the ratio of micropore surface area to total surface area for a dewaxing catalyst will be equal to or greater than 25%.

A zeolite (or other zeolitic material) can be combined with binder in any convenient manner. For example, a bound catalyst can be produced by starting with powders of both the zeolite and binder, combining and mulling the powders with added water to form a mixture, and then extruding the mixture to produce a bound catalyst of a desired size. Extrusion aids can also be used to modify the extrusion flow properties of the zeolite and binder mixture. Optionally, a binder can be composed of two or more metal oxides can also be used.

Process conditions in a catalytic dewaxing zone can include a temperature of from 200 to 450° C., preferably 270 to 400° C., a hydrogen partial pressure of from 1.8 to 34.6 MPag (˜250 to ˜5000 psi), preferably 4.8 to 20.8 MPag, a liquid hourly space velocity of from 0.2 to 10 hr ⁻¹, preferably 0.5 to 3.0 hr⁻¹, and a hydrogen circulation rate of from 35.6 to 1781 m³/m³ (˜200 to ˜10,000 SCF/B), preferably 178 to 890.6 m³/m³ (˜1000 to ˜5000 scf/B). Additionally or alternately, the conditions can include temperatures in the range of 600° F. (˜343° C.) to 815° F. (˜435° C.), hydrogen partial pressures of from 500 psig to 3000 psig (˜3.5 MPag to ˜20.9 MPag), and hydrogen treat gas rates of from 213 m³/m³ to 1068 m³/m³ (˜1200 SCF/B to ˜6000 SCF/B).

In various aspects, a hydrofinishing and/or aromatic saturation process can also be provided. The hydrofinishing and/or aromatic saturation can occur prior to dewaxing and/or after dewaxing. The hydrofinishing and/or aromatic saturation can occur either before or after fractionation. If hydrofinishing and/or aromatic saturation occurs after fractionation, the hydrofinishing can be performed on one or more portions of the fractionated product. Alternatively, the entire effluent from the last conversion or dewaxing process can be hydrofinished and/or undergo aromatic saturation.

In some situations, a hydrofinishing process and an aromatic saturation process can refer to a single process performed using the same catalyst. Alternatively, one type of catalyst or catalyst system can be provided to perform aromatic saturation, while a second catalyst or catalyst system can be used for hydrofinishing. Typically a hydrofinishing and/or aromatic saturation process will be performed in a separate reactor from dewaxing or hydrocracking processes for practical reasons, such as facilitating use of a lower temperature for the hydrofinishing or aromatic saturation process. However, an additional hydrofinishing reactor following a hydrocracking or dewaxing process but prior to fractionation could still be considered part of a second stage of a reaction system conceptually.

Hydrofinishing and/or aromatic saturation catalysts can include catalysts containing Group 6 metals, Group 8-10 metals, and mixtures thereof. In an embodiment, preferred metals include at least one metal sulfide having a strong hydrogenation function. In another embodiment, the hydrofinishing catalyst can include a Group 8-10 noble metal, such as Pt, Pd, or a combination thereof. The mixture of metals may also be present as bulk metal catalysts wherein the amount of metal is 30 wt. % or greater based on catalyst. Suitable metal oxide supports include low acidic oxides such as silica, alumina, silica-aluminas or titania, preferably alumina. Typical support materials include amorphous or crystalline oxide materials such as alumina, silica, and silica-alumina. The support materials may also be modified, such as by halogenation, or in particular fluorination. The metal content of the catalyst is often as high as 20 weight percent for non-noble metals. Some examples of hydrofinishing catalysts are catalysts that include a crystalline material belonging to the M41S class or family of catalysts, such as MCM-41, MCM-48, or MCM-50.

Hydrofinishing conditions can include temperatures from 125° C. to 425° C., preferably 180° C. to 280° C., total pressures from 500 psig (˜3.4 MPag) to 3000 psig (˜20.7 MPag), preferably 1500 psig (˜10.3 MPag) to 2500 psig (˜17.2 MPag), and liquid hourly space velocity (LHSV) from 0.1 hr⁻¹ to 5 hr⁻¹, preferably 0.5 hr⁻¹ to 2.5 hr⁻¹.

### EXAMPLES

In the following examples, the activity of various catalysts is shown T95 distillation point reduction and conversion relative to 177° C. (conversion to naphtha) and/or yield of distillate fuel boiling range products (177° C.-343° C.) relative to 177° C. conversion. The examples are based on processing using nine different types of catalysts or catalyst systems. The examples below correspond to bench-scale reactions performed using 2 cm³ of catalyst. Catalyst A corresponds to a conventional catalyst including a small pore zeolitic framework structure material. Catalysts B, C, and J correspond to high surface area, large pore size, low acidity catalysts. Catalysts D and E correspond to conventional amorphous support catalysts.

Catalyst A: 0.6 wt % Pt on USY, bound with Versal-300 alumina. The USY had a ratio of silica to alumina (SiO₂:Al₂O₃) of roughly 75:1. USY is a zeolite with 12-member ring pore channels. The weight ratio of USY to alumina binder was 65:35. Catalyst A had a surface area of roughly 600 m²/g, including ˜400 m²/g of micropore surface area and ˜200 m²/g of external surface area, an Alpha value less than 20, a collidine adsorption of less than 100 μmol/g, and a Bronsted acid site density of less than 50 μmol/g. The effective pore size of Catalyst A is based on the 12-member ring pore channels of the USY, which corresponds to a pore size of roughly 8.0 Angstroms or less.

Catalyst B: 0.3 wt % Pt and 0.9 wt % Pd on MCM-41, bound with Versal-300 alumina. The MCM-41 had a 50:1 ratio of silica to alumina (SiO₂:Al₂O₃). Catalyst B had an average pore size of 25-30 Angstroms. The weight ratio of MCM-41 to alumina binder was 65:35. Catalyst B had a total surface area of roughly 500 m²/g and an Alpha value less than 20. Additionally, the MCM-41 crystals prior to addition of metals or binder had a collidine adsorption of ˜243 μmol/g, a Bronsted acid site density of ˜75 μmol/g, and a Lewis acid site density of ˜135 μmol/g. The values for collidine adsorption and Bronsted acid site densities are believed to be representative of the corresponding values for Catalyst B (i.e., after combining the crystals with metal and binder). The total surface area corresponded to roughly 200 m²/g of micropore surface area and roughly 300 m²/g of external surface area.

Catalyst C: 0.6 wt % Pt on MCM-41, bound with Versal-300 alumina. The MCM-41 had a 50:1 ratio of silica to alumina (SiO₂:Al₂O₃). Catalyst C had an average pore size of 60 Angstroms. The weight ratio of MCM-41 to alumina binder was 65:35. The bound MCM-41 for Catalyst C (prior to inclusion of Pt) had a surface area of roughly 850 m²/g. It is believed that Catalyst C (after inclusion of Pt) had a surface area of greater than 600 m²/g and an Alpha value less than 20. The collidine uptake of Catalyst C after extrusion was ˜184 μmol/g.

Catalyst D: 0.6 wt % Pt on amorphous silica-alumina with a ratio of silica to alumina (SiO₂:Al₂O₃) of roughly 5. A separate binder was not used. Catalyst D had a surface area of roughly 450 m²/g and an Alpha value less than 20.

Catalyst E: 0.3 wt % Pt and 0.5 wt % Pd on a promoted silica-alumina support. Catalyst E is a commercially available hydrocracking catalyst.

Catalyst F: A mixed bed of Catalyst A and Catalyst B with each corresponding to roughly half the volume.

Catalyst G: 0.6 wt % Pt on MCM-41, bound with Versal-300 alumina. The MCM-41 had a 25:1 ratio of silica to alumina (SiO₂:Al₂O₃). Catalyst G had an average pore size of ˜25 Angstroms. The weight ratio of MCM-41 to alumina binder was 65:35. The bound MCM-41 for Catalyst G (prior to inclusion of Pt) had a total surface area of roughly 1000 m²/g, including roughly 900 m²/g of micropore surface area. It is believed that Catalyst G (after inclusion of Pt) had a total surface area of greater than 700 m²/g and an Alpha value less than 20. Additionally, the MCM-41 crystals prior to addition of metals or binder had a collidine adsorption of ˜405 μmol/g, a Bronsted acid site density of ˜112 μmol/g, and a Lewis acid site density of ˜195 μmol/g.

The activity of the above catalysts was investigated using a model feed corresponding to 80 vol % of a hydrotreated (low sulfur) distillate product and 20 vol % of a Group III base stock. The sulfur content of the model feed was less than 15 wppm. Table 1 shows the simulated distillation of this model feed, as determined according to ASTM D2887. As shown in Table 1, the model feed includes a T90 distillation point of greater than 370° C. and a T95 distillation point of greater than 400° C.

TABLE 1
Feed Properties

| | ° C. |
|---|---|
| IBP | 131 |
| 5 wt % off | 201 |
| 10 wt % off | 223 |
| 25 wt % off | 263 |
| 50 wt % off | 301 |
| 75 wt % off | 342 |
| 90 wt % off | 378 |
| 95 wt % off | 401 |
| 99.5 wt % off | 497 |

The model feed was exposed to the various catalysts at a pressure of 1115 psig (˜7700 kPa-g), a liquid hourly space velocity of roughly 1.0 hr⁻¹, and hydrogen treat gas flow rate equivalent to roughly 4000 scf/B (˜700 m³/m³). Temperatures were scanned between 600° F. (˜315° C.) and 750° F. (˜400° C.) at 50° F. intervals (˜30° C. intervals).

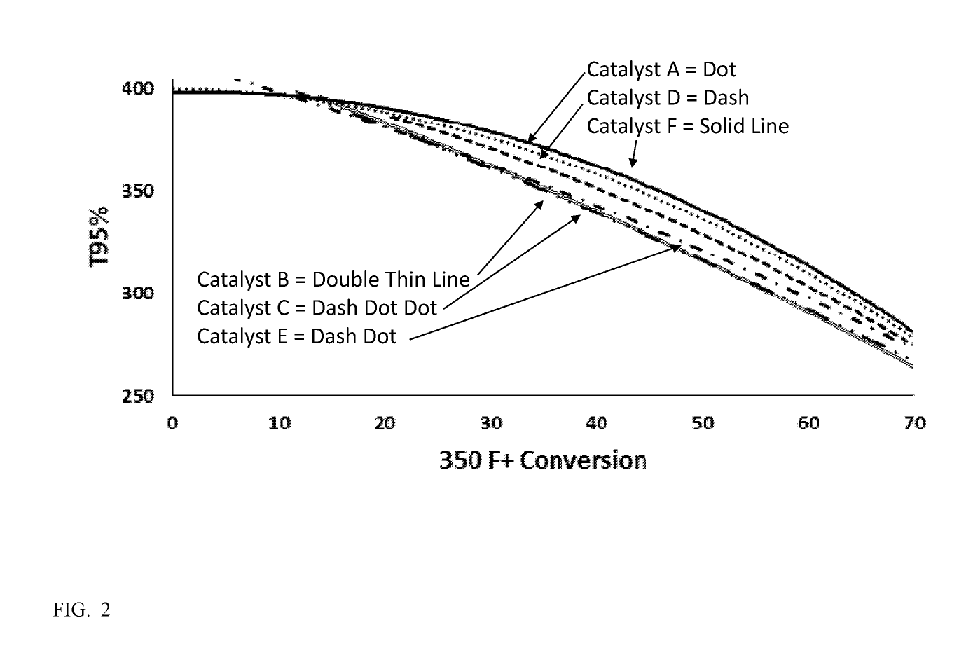

The results of testing using Catalysts A-F are shown in FIGS. 2-5. FIG. 2 shows the T95 distillation point for the product relative to the amount of 177° C. conversion for each of Catalysts A-F. The lines shown in FIG. 2 represent curve fits to measured data values.

As shown in FIG. 2, catalysts with amorphous supports (corresponding to Catalysts D and E) provide improved reduction of the T95 distillation point for low levels of 177° C. conversion relative to either the conventional zeolitic hydrocracking catalyst (Catalyst A) or the high surface area, large pore, low acidity catalysts (Catalysts B and C). These low levels correspond to roughly 30 wt % or less conversion relative to 177° C. However, to form distillate fuel products for incorporation into a distillate fuel pool (such as a diesel fuel pool), it would be desirable to achieve a T95 distillation point of 360° C. or less, or 350° C. or less. As shown in FIG. 2, when sufficiently severe conditions are used to achieve a T95 distillation point of 360° C. or less, or 350° C. or less, the high surface area, large pore, low acidity catalysts (Catalysts B and C) unexpectedly provide superior reduction of the T95 distillation point at a given level of 177° C. conversion relative to the catalysts with amorphous supports. These conditions also result in conversion of 30 wt % or more (or 35 wt % or more) of the feed relative to 177° C. In particular, for conversion amounts less than 30 wt %, the Catalyst E data points correspond to the lowest T95 distillation point values at a given level of 177° C. conversion. However, as shown by the trend lines, at conversion amounts of 30 wt % or more (or 35 wt % or more), Catalysts B and C unexpectedly provide the lowest T95 distillation points at a given level of 177° C. conversion. It is noted that the lower selectivity of Catalyst A is believed to be due to the small average pore size or roughly 8.0 Angstroms or less.

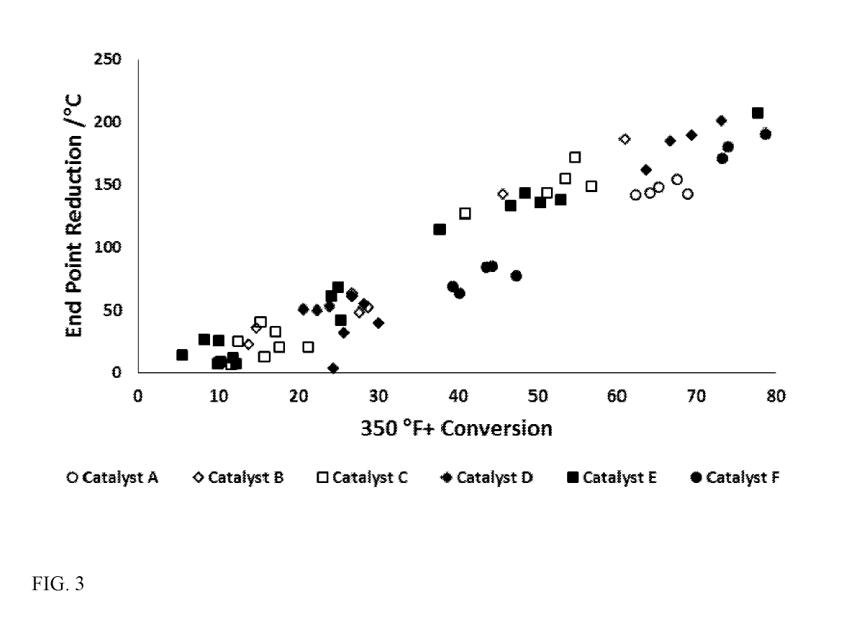

FIG. 3, which shows final boiling point reduction relative to 177° C. conversion, shows similar trends. FIG. 3 shows the individual data points of final boiling point for conversion for each catalyst. The data in FIG. 3 corresponds to the same processing runs used to fit the curves shown in FIG. 2. In FIG. 3, the amorphous catalysts provided greater final boiling point reduction at 177° C. conversion amounts of 30 wt % or less, while the high surface area, large pore, low acidity catalysts provided improved final boiling point reduction at 177° C. conversion amounts of 30 wt % or more. In particular, at 177° C. conversion amounts less than 30 wt %, the most favorable combinations of end point reduction versus 177° C. conversion correspond to data points from Catalyst E, corresponding to the promoted silica alumina support catalyst. By contrast, at 177° C. conversion amounts greater than 30 wt %, the Catalyst E data points correspond to less end point conversion than the corresponding data points for Catalyst B or Catalyst C.

Thus, even though catalysts with amorphous supports initially appear to be beneficial for end point reduction, catalysts with high surface, large pore size, and low acidity provided unexpectedly superior results for the region of interest in forming distillate fuels. It is noted that the benefit of using the high surface area, large pore size, low acidity catalysts appears to be lost when a catalyst system is used that also includes a substantial amount of a catalyst having a zeolitic framework structure, such as roughly equal amounts of a catalyst including a zeolitic framework structure and a high surface area, large pore size, low acidity catalyst. (Catalyst F)

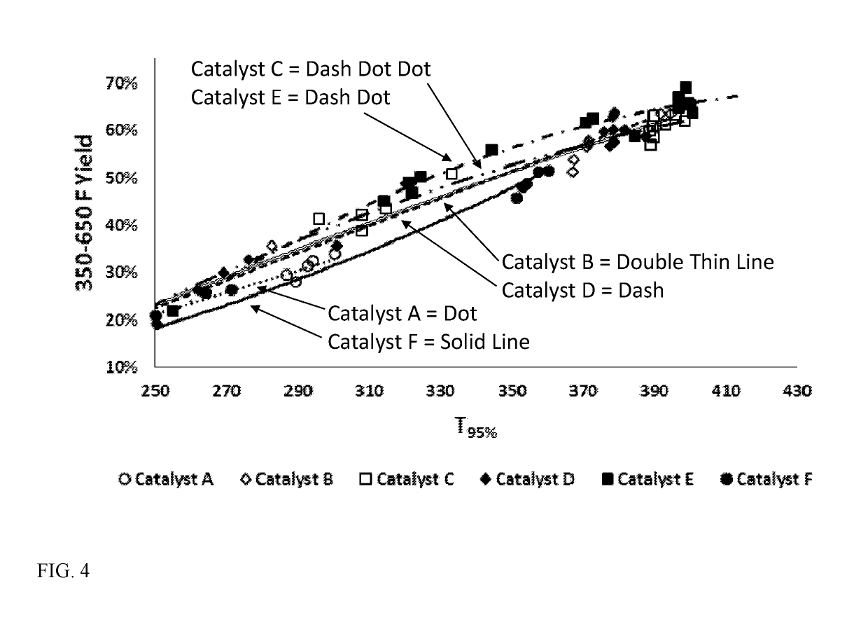

FIG. 4 shows the corresponding yield in the distillate fuel boiling range (177° C. to 343° C.) relative to the amount of reduction in the T95 distillation point for the same processing runs shown in FIGS. 2 and 3. As shown in FIG. 4, for products with T95 distillation points between 290° C. and 350° C., the high surface area, large pore size, low acidity catalysts provide similar distillate fuel yields in comparison with the catalysts based on amorphous supports. Based on FIGS. 2-4, the high surface area, large pore size, low acidity catalysts (Catalysts B and C) provided improved distillate end point reduction (FIGS. 2 and 3) while maintaining similar distillate fuel yields (FIG. 4) at a given level of 177° C. conversion. This combination of features means that feeds requiring increased amounts of distillate end point reduction (i.e., more challenging feeds) can be used to form desirable distillate fuel products while maintaining desirable distillate fuel yields.

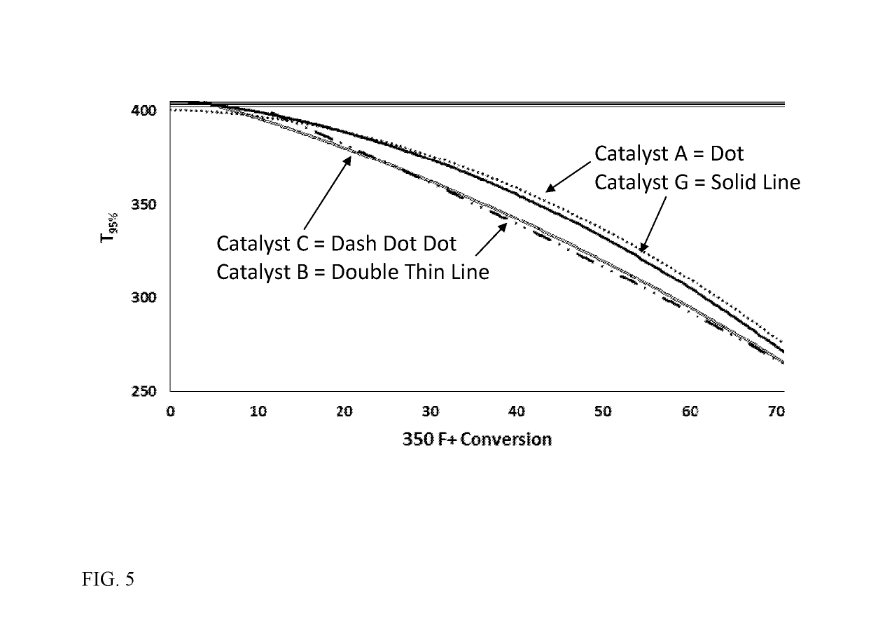

With regard to the pore size, FIG. 5 shows that reducing the pore size of a catalyst can reduce or eliminate the benefit in end point reduction. In FIG. 5, results for Catalyst G are provided in addition to the results shown in FIG. 2 for Catalysts A, B, and C. Catalyst G corresponds to a catalyst with a median pore size of only 25 Angstroms, as compared with the 40 Angstrom or 60 Angstrom pore sizes for Catalysts B and C, respectively. As shown in FIG. 5, the amount of reduction in T95 distillate point relative to 177° C. conversion for Catalyst G appears to be similar to Catalyst A, rather than being similar to Catalyst B or C. Thus, reducing the pore size of a high surface area, low acidity catalyst appears to result in a catalyst with activity more similar to a catalyst including a small pore zeolitic framework structure.

### Additional Embodiments

Embodiment 1. A method for producing a distillate fuel boiling range product, comprising: exposing a feedstock comprising a T5 distillation point of 149° C. or more and a T90 distillation point of 370° C. or more in the presence of a conversion catalyst under conversion conditions to form a converted effluent, the conversion catalyst comprising a surface area of 200 m²/g or more, an average pore size of 12 Angstroms or more, and a collidine adsorption of 300 μmol/g or less (or 250 μmol/g or less), the conversion catalyst further comprising 0.01 wt % to 5.0 wt % of a Group 8-10 noble metal supported on the conversion catalyst, wherein the conversion conditions are effective to form a converted effluent having a T95 distillation point of 360° C. or less (or 350° C. or less).

Embodiment 2. The method of Embodiment 1, wherein the conversion catalyst further comprises an average pore size of 20 Angstroms or more (or 25 Angstroms or more, or 30 Angstroms or more, or 40 Angstroms or more); or wherein the conversion catalyst further comprises an average pore size of 120 Angstroms or less; or a combination thereof.

Embodiment 3. The method of any of the above embodiments, wherein the conversion conditions are effective for conversion of 30 wt % or more of the feedstock relative to a conversion temperature of 177° C. (or 35 wt % or more).

Embodiment 4. The method of any of the above embodiments, a) wherein the conversion catalyst comprises a surface area of 500 m²/g or more, b) wherein the conversion catalyst comprises an Alpha value of 20 or less, c) wherein the conversion catalyst comprises a Bronsted acid site density of 100 μmol/g or less, d) wherein the conversion catalyst comprises a Lewis acid site density of 150 μmol/g or less, e) a combination of two or more of a)-d), or f) a combination of three or more of a)-d).

Embodiment 5. The method of any of the above embodiments, wherein i) the conversion catalyst is substantially free of crystals having a zeolitic framework with a 10-member ring pore channel, a 12-member ring pore channel, or a combination thereof; ii) the conversion catalyst is substantially free of crystals having a zeolitic framework; or iii) the conversion catalyst comprises 0.1 wt % to 10 wt % of crystals having a zeolitic framework.

Embodiment 6. The method of any of the above embodiments, wherein the conversion catalyst comprises a mesoporous material, a mesoporous organosilicate, MCM-41 or a combination thereof.

Embodiment 7. The method of any of the above embodiments, wherein the Group 8-10 noble metal comprises Pt, Pd, or a combination thereof.

Embodiment 8. The method of any of the above embodiments, I) wherein the feedstock comprises at least a portion of a dewaxed effluent from exposure of a feed to a dewaxing catalyst; II) wherein converting the feedstock comprises exposing the feedstock to a catalyst bed comprising the conversion catalyst and a dewaxing catalyst, the catalyst bed comprising a mixed bed of catalyst, a stacked bed of catalyst, or a combination thereof, the dewaxing catalyst optionally comprising a zeolitic framework structure having a 1-D, 10-member ring pore channel as the largest pore channel; or III) a combination of I) and II).

Embodiment 9. The method of any of the above embodiments, wherein the feedstock comprises 100 wppm or less of sulfur, 50 wppm or less of nitrogen, or a combination thereof.

Embodiment 10. The method of any of the above embodiments, further comprising hydroprocessing a feed comprising a 650° F.+ (˜343° C.+) portion under first hydroprocessing conditions to form a hydroprocessed effluent; and fractionating at least a portion of the hydroprocessed effluent to form a fuels boiling range fraction comprising the feedstock.

Embodiment 11. A system for producing a distillate fuel boiling range product, comprising: a hydrotreating reactor comprising a hydrotreating feed inlet, a hydrotreating effluent outlet, and at least one fixed catalyst bed comprising a hydrotreating catalyst; a separation stage having a first separation stage inlet and a second separation stage inlet, the first separation stage inlet being in fluid communication with the hydrotreating effluent outlet, the separation stage further comprising a plurality of separation stage liquid effluent outlets, one or more of the separation stage liquid effluent outlets corresponding to product outlets; and a conversion reactor comprising a conversion feed inlet, a converted effluent outlet, and at least one fixed catalyst bed comprising a conversion catalyst, the conversion feed inlet being in fluid communication with at least one separation stage liquid effluent outlet, and the conversion catalyst comprising a surface area of at least 200 m²/g, an Alpha value of 50 or less, and an effective pore size of 10 Angstroms or more, the conversion catalyst further comprising 0.01 wt % to 5.0 wt % of a Group 8-10 noble metal supported on the conversion catalyst.

Embodiment 12. The system of Embodiment 11, wherein the conversion reactor further comprises a fixed bed comprising a dewaxing catalyst; wherein the conversion reactor further comprises a fixed bed comprising a hydrofinishing catalyst; or a combination thereof.

Embodiment 13. The system of Embodiment 11 or 12, a) wherein the conversion catalyst comprises a surface area of 500 m²/g or more, b) wherein the conversion catalyst comprises an Alpha value of 20 or less, c) wherein the conversion catalyst comprises a Bronsted acid site density of 100 μmol/g or less, d) wherein the conversion catalyst comprises a Lewis acid site density of 150 μmol/g or less, e) a combination of two or more of a)-d), or f) a combination of three or more of a)-d).

Embodiment 14. The system of any of Embodiments 11 to 13, a) wherein the conversion catalyst comprises a mesoporous material, a mesoporous organosilicate, MCM-41, or a combination thereof; b) wherein the Group 8-10 noble metal comprises Pt, Pd, or a combination thereof; or c) a combination of a) and b).

Embodiment 15. A converted effluent formed by the method of any of Embodiments 1-10 or formed using the system of any of Embodiments 11-15.

Additional Embodiment A. The system of any of Embodiments 11 to 15, wherein the conversion catalyst is substantially free of crystals having a zeolitic framework; or wherein the conversion catalyst comprises 0.1 wt % to 10 wt % of crystals having a zeolitic framework.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

1. A method for producing a distillate fuel boiling range product, comprising:
exposing a feedstock comprising a T5 distillation point of 149° C. or more and a T90 distillation point of 370° C. or more in the presence of a conversion catalyst under conversion conditions to form a converted effluent, the conversion catalyst comprising a surface area of 200 m²/g or more, an average pore size of 12 Angstroms or more, and an collidine adsorption of 300 μmol/g or less, the conversion catalyst further comprising 0.01 wt % to 5.0 wt % of a Group 8-10 noble metal supported on the conversion catalyst,
wherein the conversion conditions are effective to form a converted effluent having a T95 distillation point of 360° C. or less.

2. The method of claim 1, wherein the conversion catalyst further comprises an average pore size of 25 Angstroms or more; or wherein the conversion catalyst further comprises an average pore size of 120 Angstroms or less; or a combination thereof.

3. The method of claim 1, wherein the conversion conditions are effective for conversion of 30 wt % or more of the feedstock relative to a conversion temperature of 177° C.

4. The method of claim 1, a) wherein the conversion catalyst comprises a surface area of 500 m²/g or more, b) wherein the conversion catalyst comprises an Alpha value of 20 or less, c) wherein the conversion catalyst comprises a Bronsted acid site density of 100 μmol/g or less, d) wherein the conversion catalyst comprises a Lewis acid site density of 150 μmol/g or less, e) a combination of two or more of a)-d), or f) a combination of three or more of a)-d).

5. The method of claim 1, wherein the conversion catalyst is substantially free of crystals having a zeolitic framework with a 10-member ring pore channel, a 12-member ring pore channel, or a combination thereof.

6. The method of claim 1, wherein the conversion catalyst is substantially free of crystals having a zeolitic framework.

7. The method of claim 1, wherein the conversion catalyst comprises 0.1 wt % to 10 wt % of crystals having a zeolitic framework.

8. The method of claim 1, wherein the conversion catalyst comprises a mesoporous material, a mesoporous organosilicate, or a combination thereof.

9. The method of claim 1, wherein the conversion catalyst comprises MCM-41.

10. The method of claim 1, wherein the Group 8-10 noble metal comprises Pt, Pd, or a combination thereof.

11. The method of claim 1, wherein the feedstock comprises at least a portion of a dewaxed effluent from exposure of a feed to a dewaxing catalyst.

12. The method of claim 1, wherein converting the feedstock comprises exposing the feedstock to a catalyst bed comprising the conversion catalyst and a dewaxing catalyst, the catalyst bed comprising a mixed bed of catalyst, a stacked bed of catalyst, or a combination thereof.

13. The method of claim 12, wherein the dewaxing catalyst comprises a zeolitic framework structure having a 1-D, 10-member ring pore channel as the largest pore channel.

14. The method of claim 1, wherein the feedstock comprises 100 wppm or less of sulfur, 50 wppm or less of nitrogen, or a combination thereof.

15. The method of claim 1, further comprising hydroprocessing a feed comprising a 650° F.+ (˜343° C.+) portion under first hydroprocessing conditions to form a hydroprocessed effluent; and
fractionating at least a portion of the hydroprocessed effluent to form a fuels boiling range fraction comprising the feedstock.

16. A system for producing a distillate fuel boiling range product, comprising:
a hydrotreating reactor comprising a hydrotreating feed inlet, a hydrotreating effluent outlet, and at least one fixed catalyst bed comprising a hydrotreating catalyst;
a separation stage having a first separation stage inlet and a second separation stage inlet, the first separation stage inlet being in fluid communication with the hydrotreating effluent outlet, the separation stage further comprising a plurality of separation stage liquid effluent outlets, one or more of the separation stage liquid effluent outlets corresponding to product outlets; and
a conversion reactor comprising a conversion feed inlet, a converted effluent outlet, and at least one fixed catalyst bed comprising a conversion catalyst, the conversion feed inlet being in fluid communication with at least one separation stage liquid effluent outlet, and the conversion catalyst comprising a surface area of 200 m²/g or more, a collidine adsorption of 300 μmol/g or less, and an effective pore size of 12 Angstroms or more, the conversion catalyst further comprising 0.01 wt % to 5.0 wt % of a Group 8-10 noble metal supported on the conversion catalyst.

17. The system of claim 16, wherein the conversion reactor further comprises a fixed bed comprising a dewaxing catalyst; wherein the conversion reactor further comprises a fixed bed comprising a hydrofinishing catalyst; or a combination thereof.

18. The system of claim 16, a) wherein the conversion catalyst comprises a surface area of 500 m²/g or more, b) wherein the conversion catalyst comprises an Alpha value of 20 or less, c) wherein the conversion catalyst comprises a Bronsted acid site density of 100 μmol/g or less, d) wherein the conversion catalyst comprises a Lewis acid site density of 150 μmol/g or less, e) a combination of two or more of a)-d), or f) a combination of three or more of a)-d).

19. The system of claim 16, wherein the conversion catalyst is substantially free of crystals having a zeolitic framework; or wherein the conversion catalyst comprises 0.1 wt % to 10 wt % of crystals having a zeolitic framework.

20. The system of claim 16, a) wherein the conversion catalyst comprises a mesoporous material, a mesoporous organosilicate, MCM-41, or a combination thereof; b) wherein the Group 8-10 noble metal comprises Pt, Pd, or a combination thereof; or c) a combination of a) and b).
